(19) United States
(12) Patent Application Publication
(10) Pub. No.: US 2020/0189088 A1
(43) Pub. Date: Jun. 18, 2020

(54) Striking Tool Head Retention and Protection Device

(71) Applicant: Maximilian Wolfgang Guettinger, Kennewick, WA (US)

(72) Inventor: Maximilian Wolfgang Guettinger, Kennewick, WA (US)

(73) Assignee: Maximilian Guettinger, Kennewick, WA (US)

(21) Appl. No.: 16/218,470

(22) Filed: Dec. 12, 2018

(51) Int. Cl. B25G 3/00

(52) U.S. Cl. CPC B25G 3/00; B25D 1/04

(57) ABSTRACT

The invention relates to striking tools and is a device that encircles or otherwise encapsulates the head of a hammer or other similar hand tool with the purpose of providing greater stability and a safety measure should a breakage between the tool head and the handle occur. This device could either form a hard shell system composed of two clamping portions tightened by screws or a system of ratcheting or adjustable bands forming a harness to firmly hold the head of a striking or other hand tool to its handle as a further means of attachment and safety precaution.

### BACKGROUND OF THE INVENTION:

The invention relates to striking tools and forms a novel way of providing a retaining feature for the head of said tools. Striking tools have existed for thousands of years yet a deliberate secondary form of protecting the user form tool head dislocation has yet to be developed to a degree where it is widely implemented. This invention would provide a means of ensuring that in the case of a break in their linkage there would be a modicum of safety if the break was not noticed or if the break occurred while the tool head possessed kinetic energy.

### SUMMARY OF THE INVENTION:

A device that encircles or otherwise encapsulates the head of a hammer or other similar striking tool with the purpose of providing greater stability and a safety measure should a breakage between the tool's head and the handle occur. This device would either form a hard shell system tightened by screws or a system of ratcheting or adjustable bands to firmly hold the head of a striking or other hand tool ensuring that should a break happen that the head of the tool refrain from dislocation and do injury to the user or to items/persons nearby. A first embodiment of the invention could be a hardened polymer or metal case of two pieces with sections for gripping the tool handle and securing the tool head. The two portions of this case would be fitted over the tool and tightened with screws to form a singular clamping unit which would further secure the tool head to the tool handle. A second embodiment of this invention could be a series of bands connected together to form a harness that utilizes ratcheting or frictional tightening devices such as a cinch strap to tighten around the handle and head of the tool so as to ensure retention of the tool head to the handle should a break in their conventional joining occur. The latter could be accomplished with a circular strap placed on the handle which would be connected to further strapping on the head of the tool to form a joining harness.

### BRIEF DESCRIPTION OF THE DRAWINGS:

FIG. 1 describes a side view of a potential embodiment of the invention attached to a hammer with a rectangular head detailing the mounting arrangement and screw locations.

FIG. 2 describes a front view of the potential embodiment of the invention detailed in FIG. 1 showing the two halves of the clamping system holding the hammer head and the shaft.

FIG. 3 describes one of the halves of the clamping device detailed in FIGS. 1 and 2 with through holes for screws located.

FIG. 4 describes a side view of similar embodiment of the invention fastened to a traditional claw hammer, with screw holes noted.

FIG. 5 describes a front view of the invention embodiment and its use on the claw hammer complimenting FIG. 4, with both halves of the clamping arrangement and the screw and nut locations noted.

FIG. 6 describes another embodiment of the invention on a hammer with a rectangular head that shows how straps could be used to create a harness further securing the head of the hammer to its shaft.

FIG. 7 is the front view compliment to FIG. 6 with cinching mechanism shown as well as arrangement of the harness.

FIG. 8 shows the side view of an embodiment of the invention as a harness system around a claw hammer, with cinching mechanism for the straps as noted.

FIG. 9 shows the front view compliment to FIG. 8 and further details the arrangement of the harness system.

FIG. 10 illustrates an embodiment of the invention as a harness system for restraining a tools head to its shaft as shown in FIGS. 6, 7, 8, and 9.

FIG. 11 illustrates a further embodiment of the invention as a harness system with double cinch straps further holding a hammer head to its handle.

FIG. 12 is a complimenting front view to FIG. 11 with further detailing of the harness arrangement.

### DETAILED DESCRIPTION OF THE INVENTION:

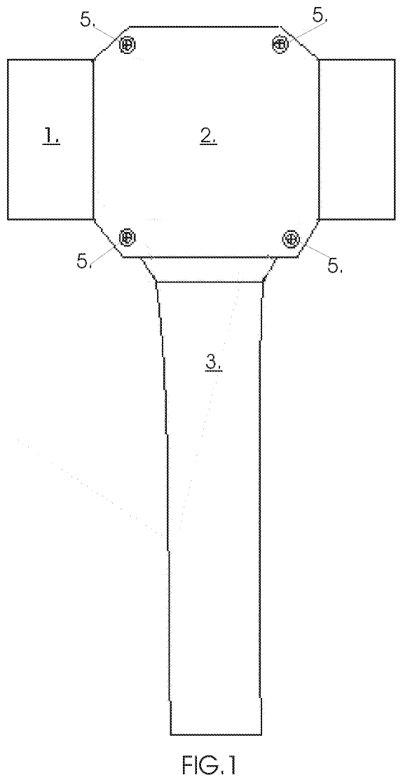

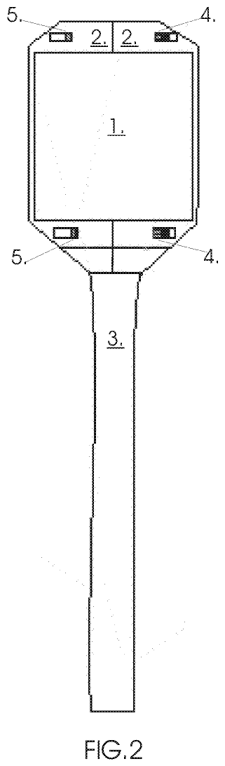

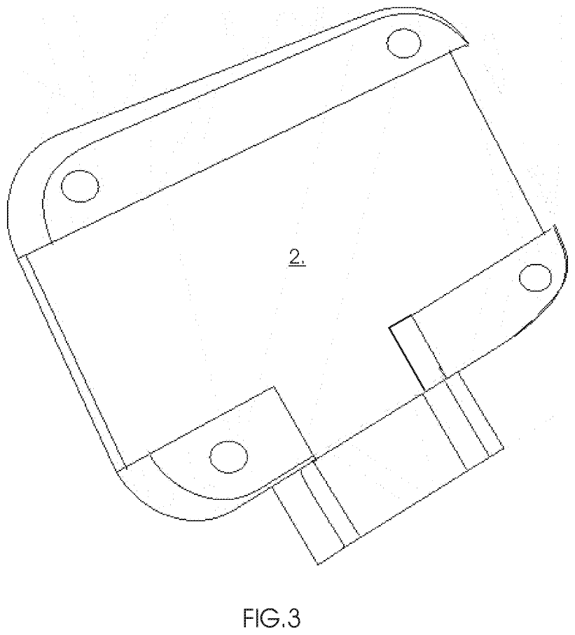

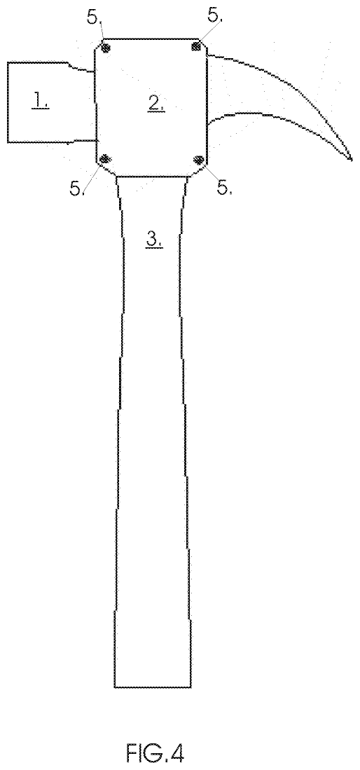

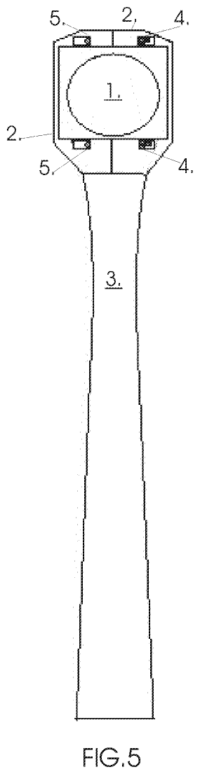

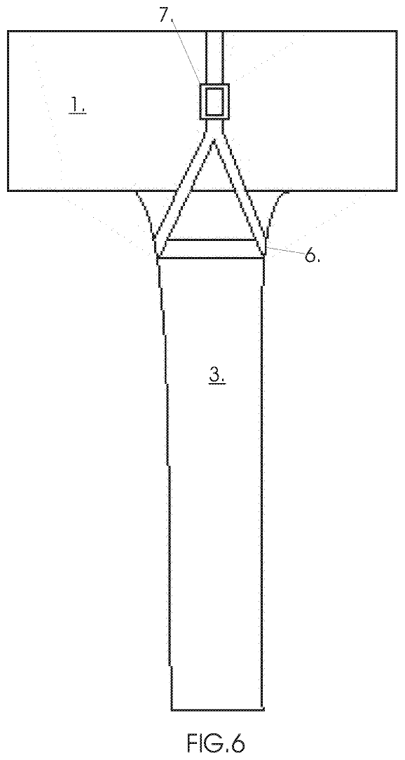

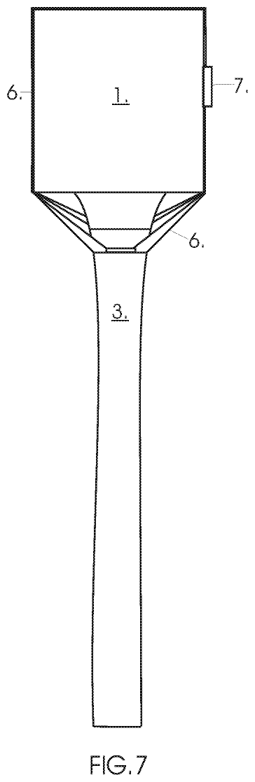

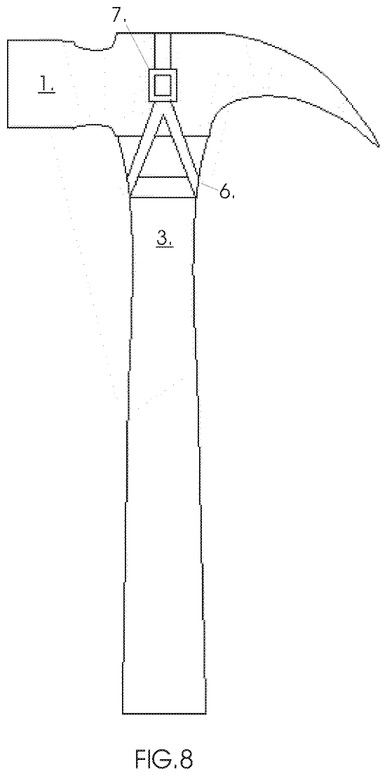

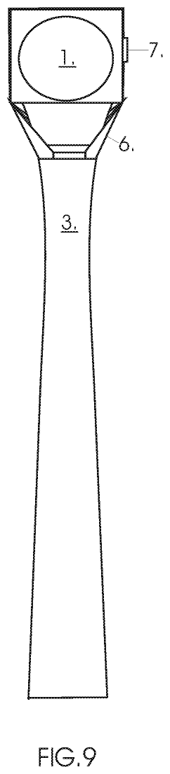

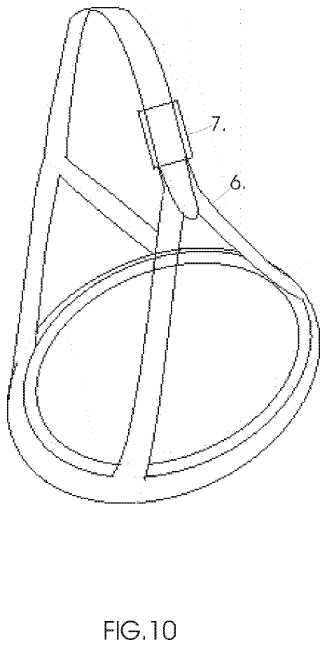

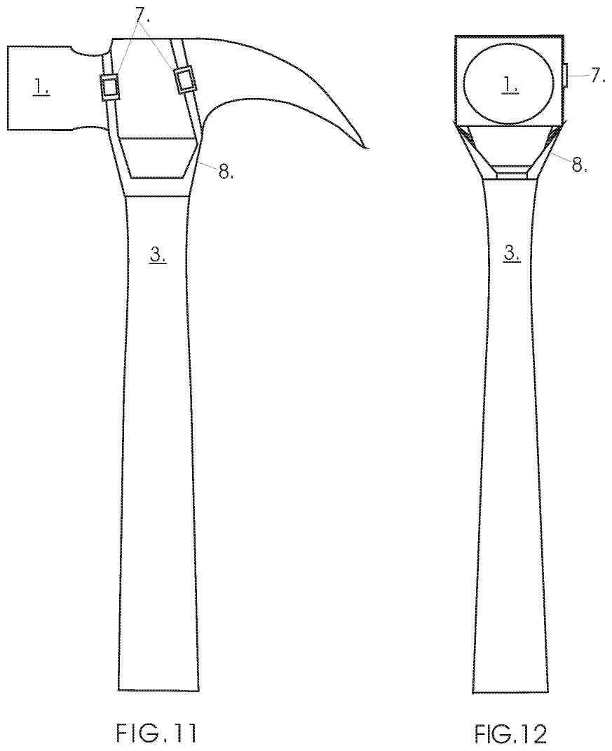

The illustrated drawings shown in the following describe preferred embodiments of the invention but are not intended to limit its present scope or forms. In reference to FIGS. 1, 2, 4, and 5 we see various views of a preferred embodiment of the invention in the form of two halves of a clamping system 2 that clamp over the head 1 and top of the shaft 3 of a hammer with each half of the clamping system 2 consisting of a formed piece of plastic or metal as shown in FIG. 3 and tightened together with screws 5 and corresponding nuts 4 to form a solid clamping piece. In reference to FIG. 3 we see that each half of the clamping section 2 consists of one piece of molded material shaped to accommodate a half portion of the hammer head and shaft with screw holes placed through the molded clamp half to facilitate joining with its mating half. The portion of the clamp that holds onto the shaft may be lined with adhesive or gripping serrations to facilitate a better hold on the hammer shaft. In reference to FIGS. 6, 7, 8, and 9 we see various views of a second preferred embodiment of the invention in which the head of a hammer 1 is further held to its shaft 3 by a system of retaining straps 6 tightened by a cinching or other mechanism 7. The straps 6 form a harness as shown in FIG. 10 which has a circular section that friction grips the hammer shaft 3 with straps leading off that are secured around the hammer head 1 and then cinched or otherwise tightened to act as a harness to further secure the hammer head to its handle. The straps may have adhesive properties to ensure a better hold. In reference to FIGS. 11 and 12 we see a dual cinch mechanism 7 type form of the strapping harness 8 which serves to demonstrate that the invention can embody many forms without deviating from its intended purpose. Although the invention's preferred embodiments have been explained it is understood that further variations and modifications may be made without departing from the spirit and scope of the invention.

1. The invention consists of an additional secondary way of securing a tool head to its shaft making it safer and sturdier to use.

2. The invention consists of either a material clamp system which clamps over the tool head and a section of the handle to form a structurally stabilizing and retaining form, or consists of a series of tighten able straps which serve to grip the tool head and firmly attach it to the tool handle.

3. The invention is designed so that if a break of the tool head from the tool handle were to occur that it would not cause a significant dislocation of the tool head before the break was noticed and the tool could by fixed or replaced.
